(19) United States
(12) Patent Application Publication
(10) Pub. No.: US 2020/0009940 A1
(43) Pub. Date: Jan. 9, 2020

(54) KINEMATICS ASSEMBLY

(71) Applicant: Mahle International GmbH, Stuttgart (DE)

(72) Inventor: Ralf Rein, Marbach (DE)

(21) Appl. No.: 16/504,277

(22) Filed: Jul. 7, 2019

(30) Foreign Application Priority Data
Jul. 9, 2018 (DE) 102018211290.8

(51) Int. Cl. B60H 1/00

(52) U.S. Cl. CPC B60H 1/00857; B60H 1/0065; B60H 2001/00707; B60H 1/00671; B60H 1/00564

(57) ABSTRACT

A kinematics assembly may include a control lever configured to drive a plurality of air flaps, a cam disc, and a bearing plate. The cam disc may include a bearing pin and the bearing plate may have a bearing opening in which the cam disc is mounted via the bearing pin. At least one groove may be disposed at the bearing opening. The bearing pin may include a tongue structured in a complementary manner to the at least one groove. The cam disc may be rotationally fixed to the bearing plate in a predefined mounting position in which the tongue is engaged in the at least one groove. The cam disc may be rotatably mounted on the bearing plate in an operating position in which the cam disc is displaced in an axial direction such that the tongue is not engaged in the at least one groove.

### CROSS-REFERENCE TO RELATED APPLICATIONS

This application claims priority to German Patent Application No. DE 10 2018 211 290.8, filed on Jul. 9, 2018, the contents of which are hereby incorporated by reference in its entirety.

### TECHNICAL FIELD

The present invention relates to a kinematics assembly with a control lever for the driving of, in particular, air flaps. The invention relates, furthermore, to an air-conditioning system with such a kinematics assembly, and a motor vehicle with such an air-conditioning system.

### BACKGROUND

A kinematics assembly comprises at least one bearing plate, a cam disc and a control lever for the driving of at least one air flap, wherein such a kinematics assembly is often prefabricated and subsequently mounted in an air-conditioning system and, in so doing, brought into operative connection with the air flaps which are to be driven. To simplify the mounting, a mounting position is predetermined here for the cam disc and for the control lever, in which the kinematics assembly is to be mounted. Subsequently, a mounting takes place of the kinematics assembly in the mounting position, wherein up until mounting often a securing of the mounting site is dispensed with, which can lead to the cam disc being twisted and thereby a subsequent mounting being made difficult.

For securing such a mounting position, i.e. for securing the position of the cam disc, elastic tongues are known, for example, which are arranged on the bearing plate and are intended to prevent a twisting of the cam disc by a blockage on the circumference thereof. Such an elastic tongue is then pressed away by a counter-rib on mounting of the kinematics assembly onto a housing and thereby a rotational movement of the cam disc is released.

A disadvantage in the solutions hitherto, however, is a comparatively great tolerance chain between the tongue of the bearing plate, housing and cam disc, whereby the entire mounting process can not be configured with process reliability.

### SUMMARY

The present invention is therefore concerned with the problem of indicating a kinematics assembly which overcomes the disadvantages known from the prior art.

This problem is solved according to the invention by the subject of the independent claim(s). Advantageous embodiments are the subject of the dependent claim(s).

The present invention is based on the general idea of realizing a securing of a “mounting position” of a kinematics assembly by a torque-proof and form-fitting connection between a cam disc and a bearing plate, wherein this form-fitting connection is released during the installing of the kinematics assembly, for example into an air-conditioning system of a motor vehicle. The kinematics assembly according to the invention has here a control lever for the driving of, in particular, air flaps, and a cam disc with a bearing pin and a bearing plate with a bearing opening, in which the cam disc is rotatably mounted via its bearing pin. At the bearing opening now according to the invention at least one groove is provided, wherein at least one tongue (rib), formed in a complementary manner to the groove, is provided on the bearing pin of the cam disc. The cam disc engages here in the predefined mounting position with its tongue into the associated groove of the bearing plate, whereby the previously described form-fitting and torque-proof connection between the cam disc and the bearing plate and the fixing of the predefined mounting position can be achieved. In an operating position, the cam disc is displaced here in axial direction of the bearing pin in such a way that it no longer engages with its tongue into the associated groove of the bearing plate and is therefore mounted rotatably thereon. The transferring into the operating position takes place here by a coupling of the bearing pin with a corresponding drive arrangement, for example a drive shaft of an electric motor, whereby the bearing pin and thereby also the cam disc are displaced in axial direction. With the kinematics assembly according to the invention it is therefore possible in a comparatively simple manner to fix a predefined mounting position and to mount the kinematics assembly with the predefined mounting position comparatively simply on an air-conditioning system. As the predefining or respectively fixing of the mounting position takes place exclusively between the cam disc and the bearing plate, i.e. independently of a housing or respectively further components of the air-conditioning system, the tolerance chain can be distinctly shortened and the process reliability can be distinctly increased. The production of the groove or respectively of the associated tongue can take place here, with cam discs or respectively bearing plates formed as plastic injection moulded parts, comparatively simply by a change to the respective plastic injection moulding tool, so that the solution according to the invention entails only marginal additional costs relating to the unit costs.

In an advantageous further development of the solution according to the invention, a guide pin is arranged on the control lever, which pin engages into a slide guide of the cam disc. The control lever can likewise be formed here as a favourably priced plastic injection moulded part or else as a metal part, wherein the guide pin is guided in the slide guide of the cam disc and on a twisting of the cam disc by a travelling along of the guide pin in the slide guide brings about a pivoting of the control lever. Hereby, a precisely predefined displacement movement of the control lever and, in so doing, a precisely predefined controlling of air flaps, fastened on the control lever, can be brought about.

Expediently, crush ribs are arranged on the bearing pin of the cam disc, which permit a fixing thereof in the mounting position in the bearing opening. Such crush ribs bring about a slight oversize of the bearing pin compared to the associated bearing opening on the bearing plate and are deformed on pressing of the bearing pin into the bearing opening, i.e. are crushed and through this fix the bearing pin in the bearing opening. Such crush ribs are likewise able to be produced comparatively simply and at a favourable cost by means of adaptation of a corresponding plastic injection moulding tool.

In an advantageous further development of the solution according to the invention, a tooth contour, for example an external toothing, is arranged on the bearing pin. By means of such an external toothing or respectively generally a tooth contour, a rotary connection of the bearing pin to a drive arrangement, for example a servomotor, can be achieved, wherein via this tooth contour a torque transmission, free of play, between the drive arrangement and the cam disc is possible, whereby in turn an extremely precise actuation of the air flaps can be achieved.

The present invention is further based on the general idea of equipping an air-conditioning system with such a previously described kinematics assembly, wherein a drive arrangement is provided which is connected in a rotationally driving manner with the cam disc, i.e. in practice with its bearing pin. With the use of the kinematics assembly according to the invention in the air-conditioning system, likewise according to the invention, the advantages of the kinematics assembly can also be transferred at the same time to the air-conditioning system.

An installation of the kinematics assembly according to the invention or respectively a production takes place here as follows:

Firstly, the cam disc is pressed with its bearing pin into the associated bearing opening of the bearing plate and is aligned with regard to its rotation angle position so that the cam disc engages with its tongue into the groove on the bearing plate side. By means of the crush ribs, for example an axial fixing of the bearing pin in the bearing opening and thereby an axial fixing of the cam disc on the bearing plate can be achieved here. A twisting of the cam disc relative to the bearing plate is no longer possible with a closed groove-and-tongue connection. Subsequently, the control lever is inserted, wherein the latter is mounted via its further bearing pin rotatably in a further bearing opening of the bearing plate and engages with its guide pin into the slide guide of the cam disc. In this prefabricated mounting position, the thus prefabricated kinematics assembly is now mounted onto a housing of the air-conditioning system. When the drive arrangement is now connected with the bearing pin of the cam disc, the cam disc is thus pressed out from its mounting position in axial direction of the bearing pin by means of a drive shaft of the drive arrangement, until the tongue on the cam disc side no longer engages into the groove on the bearing plate side, and at the same time the crush ribs are pressed out from the bearing opening, so that the cam disc is rotatably mounted again relative to the bearing plate. In this position, the kinematics assembly and the cam disc are situated in their operating position.

The present invention is based further on the general idea of using the previously described air-conditioning system with the likewise previously described kinematics assembly in a corresponding motor vehicle. Hereby, the mounting can be configured in a distinctly more process-reliable manner.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained in further detail in the following description, wherein the same reference numbers refer to identical or similar or functionally identical components.

### BRIEF DESCRIPTION OF THE DRAWINGS

There are shown here, respectively diagrammatically,

FIG. 1 shows a kinematics assembly according to the invention, in an exploded view,

FIG. 2 shows a view onto a cam disc of the kinematics assembly.

### DETAILED DESCRIPTION

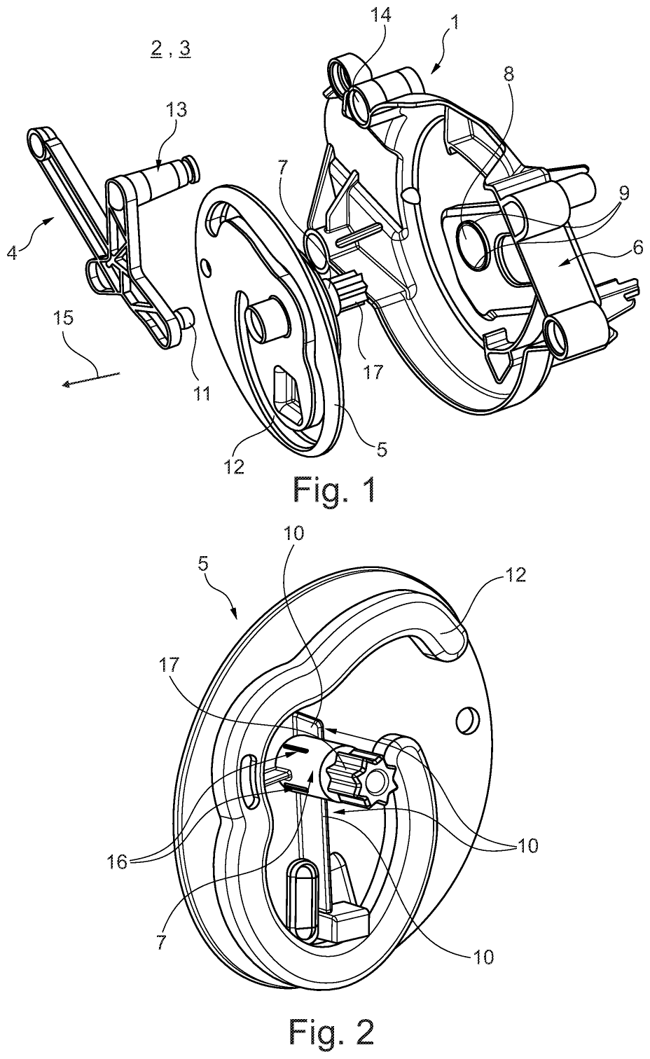

According to FIG. 1, a kinematics assembly 1 according to the invention for an air-conditioning system 2 of a motor vehicle 3, which is not illustrated in further detail, has a control lever 4 for the driving of, in particular, air flaps (not shown), and a cam disc 5 and a bearing plate 6. The cam disc 5 has here a bearing pin 7 (cf. also FIG. 2), while the bearing plate 6 has a bearing opening 8, in which the cam disc 5 is mounted by means of its bearing pin 7 in a mounting position in a torque-proof manner and rotatably in an operating position. According to the invention, at least one groove 9, here two grooves 9, is/are now provided at the bearing opening 8, wherein on the bearing pin 7 of the cam disc 5 at least one tongue 10, formed in a complementary manner to the groove 9, here two tongues 10, is/are provided. In a predefined mounting position, the cam disc 5 engages here with its tongue 10, i.e. in the present case with its tongues 10, into the associated groove 9 or respectively grooves 9 of the bearing plate 6, and creates thereby a rotationally fixed connection between the cam disc 5 and the bearing plate 6. In this predefined mounting position, the control lever 4 is likewise mounted here on the bearing plate 6 and on the cam disc 5, wherein in the mounting position the control lever 4 engages with its guide pin 11 into an associated slide guide 12 of the cam disc 5 and is mounted via a further bearing pin 13 in an associated further bearing opening 14 of the bearing plate 6.

In this mounting position, the thus prefabricated kinematics assembly 1 is mounted onto a housing of the air-conditioning system 2, wherein on the subsequent connecting of a drive arrangement, a drive shaft of the drive arrangement displaces the cam disc 5 in axial direction and removes the tongue 10 from the groove 9 and thereby releases the groove-and-tongue connection. In this operating position, the cam disc 5 is therefore displaced in axial direction 15 in such a way that it no longer engages with its tongue 10 into the associated groove 9 of the bearing plate 6 and thereby is then rotatably mounted on the latter.

Observing FIG. 2 further, it can be seen that crush ribs 16 are arranged on the bearing pin 7, which permit a fixing thereof, i.e. of the bearing pin 7 in the mounting position in the bearing opening 8 of the bearing plate 6. Furthermore on the bearing pin 7 a tooth contour 17, in particular in the manner of an internal toothing, is arranged, which subsequently enables a torque-transmitting connection to the drive shaft of the drive arrangement.

With the kinematics assembly 1 according to the invention it is possible to create a coordination of the mechanism exclusively between the cam disc 5 and the bearing plate 6 owing to the groove-and-tongue connection with the groove 9 and the tongue 10, and namely independently of a housing of the air-conditioning system 2, whereby the tolerance chain can be distinctly shortened and a process reliability can be distinctly increased. The realization of the groove-and-tongue connection can be made possible here in a comparatively simple manner by a corresponding adapting of the plastic injection moulding tools for the production of the bearing plate 6 or respectively for the production of the cam disc 5, whereby the shortening of the tolerance chain is able to be achieved with only marginal additional costs in relation to the unit costs.

1. A kinematics assembly, comprising:
a control lever configured to drive a plurality of air flaps;
a cam disc including a bearing pin;
a bearing plate with a bearing opening in which the cam disc is mounted via the bearing pin;
at least one groove disposed at the bearing opening;
the bearing pin including a tongue structured in a complementary manner to the at least one groove;
wherein the cam disc is rotationally fixed to the bearing plate in a predefined mounting position in which the tongue is engaged in the associated at least one groove; and
wherein the cam disc is rotatably mounted on the bearing plate in an operating position in which the cam disc is displaced in an axial direction of the bearing pin such that the tongue is not engaged in the at least one groove.

2. The kinematics assembly according to claim 1, further comprising a guide pin arranged on the control lever, the guide pin engaged in a slide guide of the cam disc.

3. The kinematics assembly according to claim 1, further comprising a plurality of crush ribs arranged on the bearing pin facilitating a fixing of the bearing pin, when the cam disc is in the mounting position, in the bearing opening.

4. The kinematics assembly according to claim 1, wherein the control lever includes a further bearing pin, and the bearing plate has a further bearing opening structured in a complementary manner to the further bearing pin.

5. The kinematics assembly according to claim 4 wherein the control lever is rotatably mounted via the further bearing pin engaged in the further bearing opening.

6. The kinematics assembly according to claim 1, further comprising a tooth contour arranged on the bearing pin.

7. An air-conditioning system comprising a kinematics assembly and a drive arrangement, the kinematics assembly including:
a control lever configured to drive at least one air flap;
a bearing plate with a bearing opening and at least one groove disposed at the bearing opening;
a cam disc including a bearing pin, the bearing pin including a tongue structured in a complementary manner to the at least one groove, the cam disc mounted within the bearing opening via the bearing pin;
the cam disc rotationally fixed to the bearing plate when in a mounting position in which the tongue is engaged in the at least one groove;
the cam disc rotatably mounted on the bearing plate when in an operating position in which the cam disc is displaced in an axial direction of the bearing pin such that the tongue is not engaged in the at least one groove; and
wherein the drive arrangement is connected with the cam disc in a rotationally driving manner.

8. The air-conditioning system according to claim 7, wherein the at least one air flap is connected with the control lever.

9. A motor vehicle comprising an air-conditioning system including a kinematics assembly and a drive arrangement, the kinematics assembly including:
a control lever configured to drive at least one air flap;
a bearing plate with a bearing opening and at least one groove disposed at the bearing opening;
a cam disc including a bearing pin, the bearing pin including a tongue structured in a complementary manner to the at least one groove, the cam disc mounted within the bearing opening via the bearing pin;
the cam disc rotationally fixed to the bearing plate when in a mounting position in which the tongue is engaged in the at least one groove;
the cam disc rotatably mounted on the bearing plate when in an operating position in which the cam disc is displaced in an axial direction of the bearing pin such that the tongue is not engaged in the at least one groove; and
wherein the drive arrangement is connected with the cam disc in a rotationally driving manner.

10. The motor vehicle according to claim 9, further comprising a guide pin arranged on the control lever, the guide pin engaged in a slide guide of the cam disc.

11. The motor vehicle according to claim 9, further comprising a plurality of crush ribs arranged on the bearing pin facilitating a fixing of the bearing pin in the bearing opening when the cam disc is in the mounting position.

12. The motor vehicle according to claim 9, wherein the control lever includes a further bearing pin, and the bearing plate has a further bearing opening structured in a complementary manner to the further bearing pin.

13. The motor vehicle according to claim 12, wherein the control lever is rotatably mounted via the further bearing pin engaged in the further bearing opening.

14. The motor vehicle according to claim 9, further comprising a tooth contour arranged on the bearing pin.

15. The air-conditioning system according to claim 8, wherein:
the control lever includes a guide pin arranged in a slide guide of the cam disc and a further bearing pin engaged within a further bearing opening of the bearing plate; and
the guide pin is slideably engaged in the slide guide such that a twisting of the cam disc adjusts a position of the control level and actuates the at least one air flap.

16. The kinematics assembly according to claim 1, wherein:
the cam disc includes a slide guide, the bearing plate has a further bearing opening, and the control lever includes a guide pin and a further bearing pin; and
the guide pin is slideably engaged in the slide guide and the further bearing pin is engaged in the further bearing opening when the cam disc is in the mounting position.

17. The kinematics assembly according to claim 2, wherein the guide pin is slideably engaged in the slide guide such that a twisting of the cam disc adjusts a position of the control level.

18. The kinematics assembly according to claim 3, wherein the plurality of crush ribs are deformable and project from the bearing pin such that the bearing pin is radially larger than the bearing opening, and wherein a deformation of the plurality of crush ribs axially secures the bearing pin within the bearing opening when the cam disc is in the mounting position.

19. The kinematics assembly according to claim 6, wherein the tooth contour includes a plurality of teeth facilitating a torque-transmitting, play-free connection between the cam disc and a drive arrangement.

20. The kinematics assembly according to claim 6, wherein the tooth contour is an external toothing.
